(19) United States
(12) Patent Application Publication
(10) Pub. No.: US 2025/0139427 A1
(43) Pub. Date: May 1, 2025

(54) METHOD AND APPARATUS FOR CONTROLLING LOSS SCALE BY CLASS FOR POST-CALIBRATION AND COMPUTER PROGRAM

(71) Applicant: CHUNG ANG University industry Academic Cooperation Foundation, Seoul (KR)

(72) Inventors: JONG WON CHOI, Seoul (KR); SEUNG JIN JUNG, Seoul (KR); SEUNG MO SEO, Seoul (KR)

(21) Appl. No.: 18/396,927

(22) Filed: Dec. 27, 2023

(30) Foreign Application Priority Data
Oct. 27, 2023 (KR) 10-2023-0145899

(51) Int. Cl. G06N 3/08

(52) U.S. Cl. CPC G06N 3/08

(57) ABSTRACT

A method for controlling a loss scale by class includes identifying class-wise losses of a neural network, analyzing a relative correlation by normalizing the identified class-wise losses, estimating class-wise loss scaling weights according to a result of the analyzing of the relative correlation, and calculating a weighted sum of the class-wise losses by applying the estimated class-wise loss scaling weights to the identified class-wise losses of the neural network, and deriving a total loss of the neural network by summing the identified class-wise losses and the weighted sum of the class-wise losses.

### PRIORITY

This application claims the benefit under 35 USC § 119 of Korean Patent Application No. 10-2023-0145899, filed on Oct. 27, 2023, in the Korean Intellectual Property Office, the entire disclosure of which is incorporated herein by reference for all purposes.

### BACKGROUND

### 1. Field

Embodiments of the disclosure relate to a technology for controlling a loss scale by class for post-calibration.

### 2. Description of Related Art

With advances in deep learning algorithms, performance improvements that are effective in many machine learning tasks are being seen. In particular, industries where safety is important, such as the medical and autonomous driving industries, require high performance or better predictive calibration to prevent unpredictable errors. To solve the problem, studies on calibration of the prediction results of deep learning models to indicate confidence of predictions of model calibration are expanding.

However, according to existing studies, large additional costs are incurred to calibrate model prediction results, and since calculations have to be performed to calibrate the prediction results while a target model is being trained, in order to obtain more accurately calibrated prediction results, performance degradation is inevitable. In addition, a deep learning model learns biased information from various variables that exist in the data, and the confidence of the model's predictions from biased information varies for each class. However, because existing studies do not consider these aspects, it may not be possible to obtain accurately calibrated results.

Meanwhile, the expected calibration error is one of important indicators that evaluate the degree of calibration of a model, and looking at a result of all samples and results of samples divided by class, it can be seen that the degree of confidence calibration is different for each class.

Examples of the related art includes KR 10-2022-0151170A.

### SUMMARY

The present disclosure has been made in consideration of the foregoing technical background, and intended to suggest a new calibration mechanism for synchronizing class-wise training losses and provide a method and apparatus for controlling a loss scale by class for post-calibration, capable of improving the accuracy of calibrated prediction results by performing synchronization by a calibration method.

In order to solve the above-mentioned problems, the present disclosure includes the following configurations.

In one general aspect, there is provided a method for controlling a loss scale by class that is executed in a computing device including one or more processors and a memory storing one or more programs executed by the one or more processors, the method including identifying class-wise losses of a neural network, analyzing a relative correlation by normalizing the identified class-wise losses, estimating class-wise loss scaling weights according to a result of the analyzing of the relative correlation, and calculating a weighted sum of the class-wise losses by applying the estimated class-wise loss scaling weights to the identified class-wise losses of the neural network, and deriving a total loss of the neural network by summing the identified class-wise losses and the weighted sum of the class-wise losses for each class.

In another general aspect, there is provided an apparatus for controlling a loss scale by class that is a computing device including one or more processors and a memory storing one or more programs executed by the one or more processors, the apparatus including a loss identification module configured to identify class-wise losses of a neural network, an analysis module configured to analyze a relative correlation by normalizing the identified class-wise losses, a weight estimation module configured to estimate class-wise loss scaling weights according to a result of analyzing the relative correlation, and a total loss derivation module configured to calculate a weighted sum of the class-wise losses by applying the estimated class-wise loss scaling weights to the identified class-wise losses of the neural network, and derive a total loss of the neural network by summing the identified class-wise losses and the weighted sum of the class-wise losses for each class.

In still another general aspect, there is provided a computer program stored in a non-transitory computer readable storage medium, including one or more instructions that, when executed by a computing device having one or more processors, cause the computing device to perform operations of identifying class-wise losses of a neural network, analyzing a relative correlation by normalizing the identified class-wise losses, estimating class-wise loss scaling weights according to a result of the analyzing of the relative correlation, and calculating a weighted sum of the class-wise losses by applying the estimated class-wise loss scaling weights to the identified class-wise losses of the neural network, and deriving a total loss of the neural network by summing with the identified class-wise losses and the weighted sum of the class-wise losses for each class.

### BRIEF DESCRIPTION OF THE DRAWINGS

FIG. 1 is a diagram illustrating a configuration of an apparatus for controlling a loss scale by class according to one embodiment of the present disclosure.

FIGS. 2A to 2D are exemplary diagrams illustrating correlation between calibration error and each loss according to one embodiment.

FIG. 3 is an exemplary diagram illustrating an entire framework in which a method for controlling a loss scale by class according to one embodiment is performed.

FIG. 4 is a flowchart of the method for controlling a loss scale by class according to one embodiment.

FIGS. 5A to 5E are a set of graphs for describing calibration errors and loss analysis by class.

FIGS. 6 to 9D are exemplary diagrams for describing effects derived by a method for controlling a loss scale by class according to one embodiment.

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only for illustrative purposes and the present disclosure is not limited thereto.

In describing the embodiments of the present disclosure, when it is determined that detailed descriptions of known technology related to the present disclosure may unnecessarily obscure the gist of the present disclosure, the detailed descriptions thereof will be omitted. The terms used below are defined in consideration of functions in the present disclosure, but may be changed depending on the customary practice, the intention of a user or operator, or the like. Thus, the definitions should be determined based on the overall content of the present specification. The terms used herein are only for describing the embodiments of the present disclosure, and should not be construed as limitative. Unless expressly used otherwise, a singular form includes a plural form. In the present description, the terms “including”, “comprising”, “having”, and the like are used to indicate certain characteristics, numbers, steps, operations, elements, and a portion or combination thereof, but should not be interpreted to preclude one or more other characteristics, numbers, steps, operations, elements, and a portion or combination thereof.

Further, it will be understood that, although the terms first, second, etc. may be used herein to describe various elements, these elements should not be limited by these terms. These terms may be used to distinguish one element from another element. For example, without departing from the scope of the present disclosure, a first element could be termed a second element, and similarly, a second element could be termed a first element.

An apparatus for controlling a loss scale by class according to embodiments of the present disclosure may be implemented by at least one computer device, and a method for controlling a loss scale by class according to embodiments of the present disclosure may be performed through at least one computer device included in the apparatus for controlling a loss scale by class. In this case, a computer program according to one embodiment of the present disclosure may be installed and driven in the computer device, and the computer device may perform the method for controlling a loss scale by class according to embodiments of the present disclosure according to control of the driven computer program. The above-described computer program may be stored in a computer-readable recording medium to execute the method for controlling a loss scale by class on a computer in conjunction with the computer device.

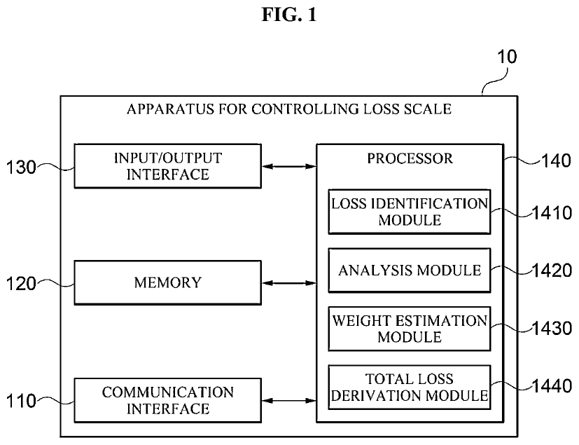

FIG. 1 is a diagram illustrating a configuration of an apparatus for controlling a loss scale by class according to one embodiment of the present disclosure.

Referring to FIG. 1, an apparatus 10 for controlling a loss scale by class according to one embodiment includes a communication interface 110, a memory 120, an input/output interface 130, and a processor 140.

The communication interface 110 may provide a function for the apparatus 10 for controlling a loss scale by class to communicate with other devices through a network. As one example, a request, command, data, file, and the like generated by the processor 140 of the apparatus 10 for controlling a loss scale by class according to a program code stored in a recording device such as the memory 120 may be transmitted to other devices such as the apparatus 10 for controlling a loss scale by class through the network under control of the communication interface 110.

Conversely, a signal, command, data, file, and the like from other devices may be received through the communication interface 110 of the apparatus 10 for controlling a loss scale by class via the network. The signal, command, data, and the like received through the communication interface 110 may be transmitted to the processor 140 or memory 120, and files and the like may be stored in a storage medium (the above-described permanent storage device) that may be included in the apparatus 10 for controlling a loss scale by class.

The network may include any one or more of the following networks: personal area network (PAN), local area network (LAN), campus area network (CAN), metropolitan area network (MAN), wide area network (WAN), broadband network (BBN), the Internet, or the like. In addition, the network may include any one or more of network topologies including a bus network, star network, ring network, mesh network, star-bus network, tree or hierarchical network, or the like, but the network is not limited thereto.

The memory 120 is a computer-readable recording medium, and may include a random access memory (RAM) and a permanent mass storage device such as a read only memory (ROM), a disk drive, and a server. Here, the permanent mass storage device such as the ROM and the disk drive may be included in the apparatus 10 for controlling a loss scale by class as a separate permanent storage device distinct from the memory 120.

In addition, an operating system and at least one program code may be stored in the memory 120. The software components may be loaded into the memory 120 from a computer-readable recording medium separate from the memory 120. The separate computer-readable recording media may include computer-readable recording media such as floppy drives, disks, tapes, DVD/CD-ROM drives, memory cards, SSDs, USBs, or the like.

In another embodiment, software components may be loaded into the memory 120 through the communication interface 110 rather than the computer-readable recording medium. For example, software components may be loaded into the memory 120 of the apparatus 10 for controlling a loss scale by class based on a computer program installed by files received over the network.

The input/output interface 130 may be a means for interfacing with an input/output device. For example, an input device of the input/output device may include a device such as a microphone, keyboard, or mouse, and an output device may include a device such as a display or speaker. For another example, the input/output interface 130 may be a means for interfacing with a device in which input and output functions are integrated into one, such as a touch screen. The input/output device may be integrated with the apparatus 10 for controlling a loss scale by class as one device.

The processor 140 may be a component for processing instructions of a computer program by performing basic arithmetic, logic, and input/output operations. Instructions may be provided to the processor 140 by the memory 120 or the communication interface 110. For example, the processor 140 may execute instructions received according to program codes stored in a recording device such as the memory 120.

The processor 140 of the apparatus 10 for controlling a loss scale by class according to one embodiment includes a loss identification module 1410, an analysis module 1420, a weight estimation module 1430, and a total loss derivation module 1440.

The loss identification module 1410 identifies the class-wise losses of a neural network.

Then, the analysis module 1420 analyzes a relative correlation by normalizing the identified class-wise losses.

The weight estimation module 1430 estimates class-wise loss scaling weights according to a result of the analyzing of the relative correlation.

The total loss derivation module 1440 derives a total loss of the neural network by calculating a weighted sum of the class-wise losses by applying the class-wise loss scaling weights estimated by the weight estimation module 1430 to the class-wise losses identified by the loss identification module 1410, and summing the class-wise losses identified by the loss identification module 1410 and the weighted sum of the class-wise losses for each class. Here, the total loss may mean a total loss for post-calibration for the neural network.

The apparatus 10 for controlling a loss scale by class according to one embodiment may improve the prediction accuracy of model result values by synchronizing the class-wise losses by introducing a class-wise loss scaling method that considers the difference between confidences of a plurality of classes.

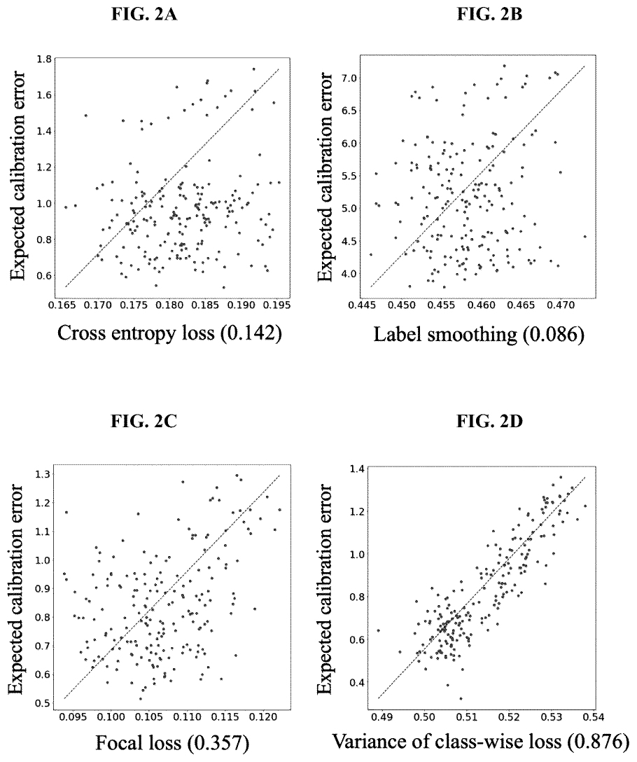

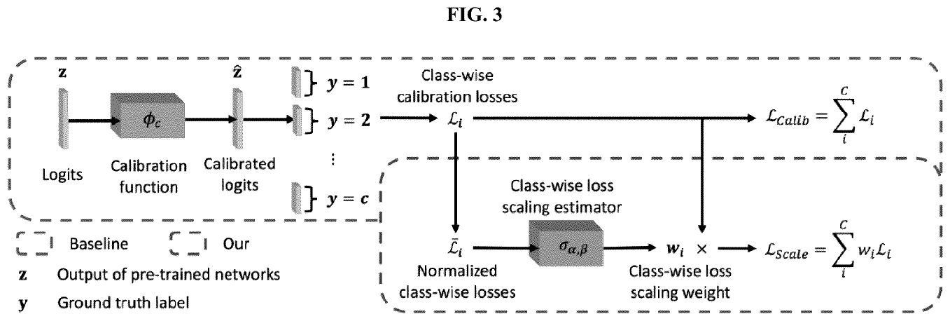

FIGS. 2A to 2D are exemplary diagrams illustrating correlation between calibration error and each loss according to one embodiment. As can be seen in FIGS. 2A to 2D, the more linear a correlation coefficient between the expected calibration error and the loss, the lower the calibration error. In plots, it can be seen that variance of class-wise losses shows the highest correlation with the calibration error. Therefore, by synchronizing the class-wise losses (in other words, by minimizing the variance of class-wise losses), the model may derive a well-calibrated prediction result. In graphs of FIGS. 2A to 2D, parentheses in captions indicate correlation coefficients.

An asynchronous class-wise training loss may be a cause of preventing a target model from being properly calibrated. As partially illustrated in FIGS. 2A to 2D, it can be seen that the variance of class-wise losses is highly correlated with calibration error.

The asynchronous class-wise training loss typically occurs while deep learning models are trained due to varying degrees of intra-class shape variation and inter-class similarity.

Therefore, the apparatus 10 for controlling a loss scale by class according to one embodiment may suggest a new calibration mechanism for synchronizing the class-wise training losses.

That is, by using a pre-trained model as an initial model, additional calculations for model calibration may be reduced and a calibration framework may be designed to be easily used in post-calibration methods. In the present specification, “model” means a neural network model including one or more neural networks (that is, artificial neural networks).

Model calibration may calibrate the degree of confidence of a model during training to prevent the degree of confidence from being under or over confident. This is because transformations such as model capacity, batch normalization, and weight reduction may affect the degree of confidence of a model. Model calibration requires a balance between the degree of confidence and accuracy, and as a result, as the degree of confidence of the calibrated model increases, its accuracy decreases when compared to a model specifically trained to improve accuracy.

Post-hoc calibration adjusts output logits of a pre-trained model. This is a model trained without considering a calibration method.

According to the apparatus 10 for controlling a loss scale by class according to one embodiment, by reusing a pre-trained neural network and performing post-correction on result values output from the pre-trained model, uncertainty may be controlled and prediction probability may be corrected. Since in the apparatus 10 for controlling a loss scale by class, the pre-trained network is reused, training may be carried out at low costs.

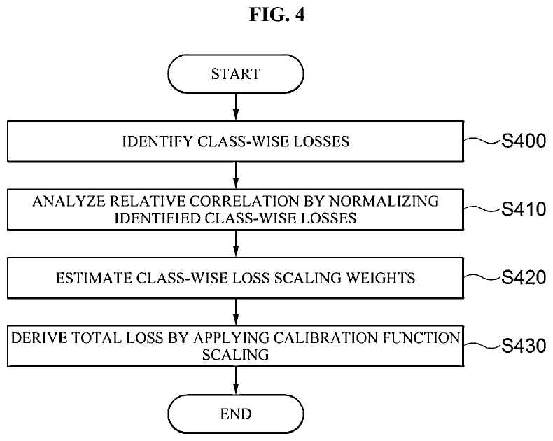

FIG. 3 is an exemplary diagram illustrating an entire framework in which a method for controlling a loss scale by class according to one embodiment is performed, and FIG. 4 is a flowchart of the method for controlling a loss scale by class according to one embodiment.

The method for controlling a loss scale by class according to one embodiment may suggest a new calibration method for post-calibration referred to as class-wise loss scaling. First, an analysis of the high correlation between the calibration error and the variance of class-wise training losses is presented. Then, based on a result of the analysis, a class-wise loss scaling estimator may be suggested to define the class-wise calibration loss and control the variance of the class-wise training losses.

Then, a relative degree of confidence is considered by taking the class-wise losses and normalizing the class-wise losses. Then, using the normalized class-wise losses, the class-wise loss scaling weight may be obtained through the estimator. Learning of a calibration function is controlled by an estimated class-wise loss scale factor.

Looking at the method for controlling a loss scale by class according to one embodiment in more detail with reference to FIG. 4, first, the method for controlling a loss scale by class according to an embodiment identifies class-wise losses of a neural network using a preset calibration function (S400).

The identifying of the class-wise losses may be performed by a baseline in FIG. 3.

In one embodiment, top three classes with the highest class-wise training losses may be selected first.

Then, an additional parametric layer is trained using only the class-wise training loss of the selected class.

In one aspect, an i-th class-wise loss [symbol] _{C}_{ᵢ} is calculated by Equation 1 below.

$${ℒ}_{{C}_{i}} = - {\sum }_{( x , y ) ∈ {𝒟}_{i}} δ ( y ) log ( {ϕ}_{c} ( x ) ) \qquad [ Equation 1 ]$$

Here, δ may convert a given scalar y into a corresponding one-hot vector, and c may be implemented as a preset calibration function. Dᵢ may be a sample set of class i. All samples labeled with class i may be added to Dᵢ.

Here, the one-hot vector is a vector created by assigning a unique binary vector consisting of 0 and 1 to a given scalar, where the binary vector may be defined in such a way that only one value (for example, a value corresponding to a corresponding class) out of all values is 1 and the rest are 0.

It is difficult to manually assign class-wise weights because the high and low confidence classes are unknown and vary depending on a data set and network architecture. To solve this problem, a new sigmoid-based function that controls the class-wise weight according to a training loss value may be designed to accelerate the balance between the class-wise training losses.

To this end, a relative correlation is analyzed by normalizing the identified class-wise losses (S410). That is, to relative sizes between class-wise losses, the class-wise losses may be normalized.

In one aspect, in the analyzing operation, the class-wise loss is normalized by Equation 2 below.

$${\overline{ℒ}}_{{C}_{i}} = \frac{{ℒ}_{{C}_{i}} - 𝔼 [ {ℒ}_{{C}_{i}} ]}{\sqrt{𝔼 [ {ℒ}_{{C}_{i}}^{2} ] - {𝔼}^{2} [ {ℒ}_{{C}_{i}} ]}} \qquad [ Equation 2 ]$$

[symbol] _{C}_{ᵢ}: Normalized class-wise loss

Here, the loss is normalized to a normal distribution with mean 0 and unit standard deviation. [symbol] [•] represents a mean of the values in parentheses.

Then, class-wise loss scaling weights are estimated according to a result of the analysis of the relative correlation (S420). Here, the loss scaling weight is a value used to determine the amount of learning to be done. When the loss is large, learning is recognized as insufficient, so a larger scale is assigned, and when the loss is small, learning is recognized as overconfidence, so a smaller scale is assigned. That is, the scaling weight is assigned so that when the loss is large, much learning is to be done, and when the loss is small, only a little learning is to be done.

In one aspect, in the operation of estimating the loss scaling weights, a class-wise weight parameter may be estimated using a sigmoid basis function, and the class-wise loss scaling weight may be estimated based on the estimated class-wise weight parameter.

That is, the class-wise weight parameter may be estimated using Equation 3 below.

$${w}_{i} = σ ( {\overline{ℒ}}_{{C}_{i}} ; α , β ) := \frac{β}{1 + exp ( - {\overline{ℒ}}_{{C}_{i}} / α )} - \frac{β}{2} \qquad [ Equation 3 ]$$

α and β are parameters for determining the shape of the sigmoid basis function and are automatically optimized; specifically, α is a slope parameter and β is a horizontal translation parameter. That is, α determines the size of the slope and β changes a bound size for the class-wise training loss.

From Equation 3, it can be seen that the range of σ( [symbol] _{C}_{ᵢ}; α, β) is from

$$- \frac{β}{2}$$

to β/2.

In addition, in order to optimize values of α and β, an objective function such as Equation 4 is designed to reduce the variance of the class-wise training losses as follows.

$$[ Equation 4 ]$$

$${ℒ}_{σ ( a , β )} = η ( {ℒ}_{C}^{1} ) \approx \sqrt{{\sum }_{i = 1}^{c} {( {ℒ}_{{C}_{i}}^{0} - σ ( {\overline{ℒ}}_{{C}_{i}}^{1} ; α , β ) \cdot ( {ℒ}_{{C}_{i}}^{1} - {ℒ}_{{C}_{i}}^{0} ) - 𝔼 [ {ℒ}_{C}^{1} ] )}^{2}}$$

Here, η( [symbol] _{C}¹) is a function for the standard deviation of the class-wise training losses after first iteration, [symbol] _{C}_{ᵢ}⁰ is a class-wise training loss for an i-th class before first training iteration, and [symbol] _{C}_{ᵢ}¹ is a class-wise training loss for the i-th class after the first training iteration.

In order to simplify the objective function, the variance of the class-wise training losses is approximated in a current iteration using a first-order Taylor series. As an example, sequential least squares programing (SLSQP) optimizer may be used to find an optimal solution for α and β and fix optimal values during the entire training sequence for calibration scaling.

Then, a weighted sum of the class-wise losses is calculated by applying the estimated class-wise loss scaling weights to class-wise losses of the neural network, and a total loss of the neural network is derived by summing the class-wise losses and the weighted sum of the class-wise losses for each class (S430).

That is, the class-wise loss scaling weights are estimated using the optimal values of α and β calculated in the estimating operation and the weighted sum of the class-wise losses is calculated applying the class-wise loss scaling weights to the class-wise losses. The class-wise loss scaling for the i-th class may be defined as Equation 5.

$${ℒ}_{{scale}_{i}} = {w}_{i} {ℒ}_{{C}_{i}} \qquad [ Equation 5 ]$$

In one embodiment, the total loss of the neural network is derived by Equation 6 below. That is, the total loss of the neural network may be derived by summing the class-wise losses and the weighted sum of the class-wise losses for each class.

$${ℒ}_{Total} = {\sum }_{i = 1}^{C} ( 1 + {w}_{i} ) {ℒ}_{{C}_{i}} \qquad [ Equation 6 ]$$

$$c : Number of classes$$

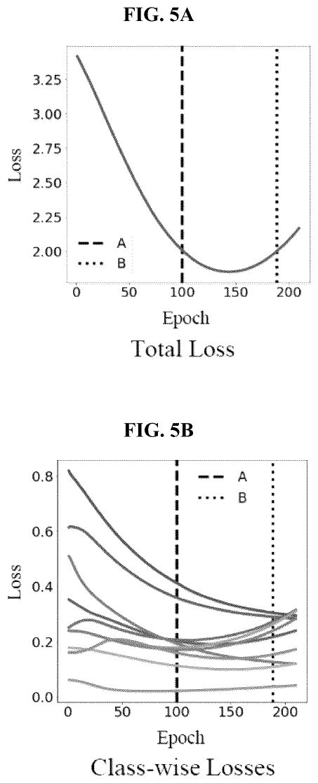

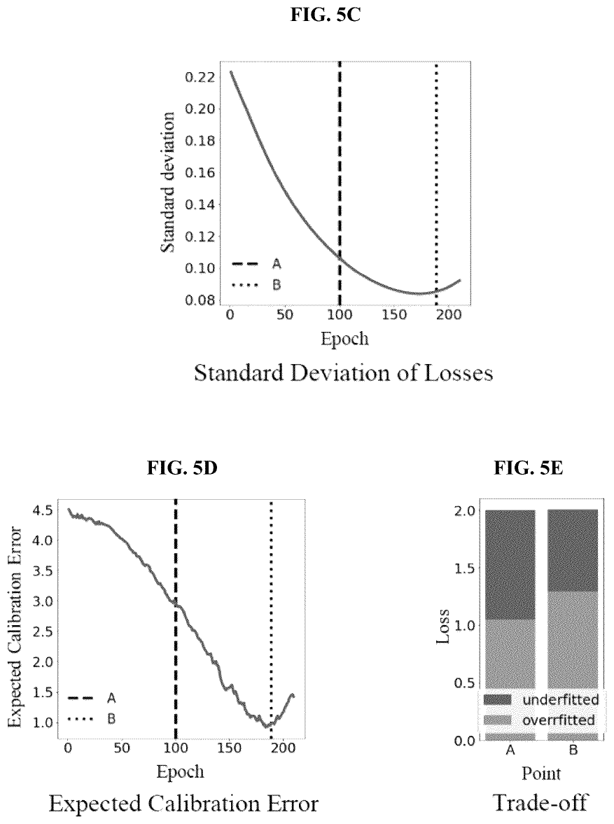

FIGS. 5A to 5E are a set of graphs for describing calibration errors and loss analysis by class.

FIGS. 5A, 5B, 5C, and 5D show changes in total loss, class-wise losses, standard deviation of class-wise losses, and expected calibration errors by epoch, respectively. A and B represent points with the same overall loss, but the class-wise loss varies in A compared to B. Through this, it can be seen that the expected calibration errors may be reduced by minimizing the variance of the class-wise losses. FIG. 5E shows a loss ratio of three classes that are underfitted and another class that is overfitted while the total loss is preserved.

In FIGS. 5A to 5D, changes in the total loss, class-wise losses, the standard deviation of losses, and expected calibration errors (ECE) according to training epochs may be identified.

A and B refer to two points with the same total loss in different training epochs. That is, the total losses for the two points A and B are the same, but the ECE values vary, which shows that the total training loss is not related to the calibration error. Therefore, minimizing the total loss does not make the model trained to be well calibrated.

In FIG. 5B, there is a large difference between the class-wise training losses at epoch 0. Therefore, the diversity of class-wise training losses poses various types of problems, including the problem of class overload.

In addition, through similar trends in FIGS. 5C and 5D, it can be seen that the ECE value is highly correlated with the standard change in class-wise training loss during model training.

Visualizing the total loss composition of points A and B as shown in FIG. 5E, balance between the class-wise training losses for the underfitting class and the overfitting class may be easily found. That is, the calibration error may be reduced while the total loss is maintained by adding the decrement of the class-wise training loss for the underfitting class to the class-wise training loss for the overfitting class.

As can be seen in FIGS. 5A to 5E, the variation of the class-wise training losses is an important factor in controlling the degree of post-calibration. In addition, since the class-wise training loss may be compensated between the overfitting class and the underfitting class with the total loss preserved, performance degradation of the pre-trained model after post-calibration may be prevented.

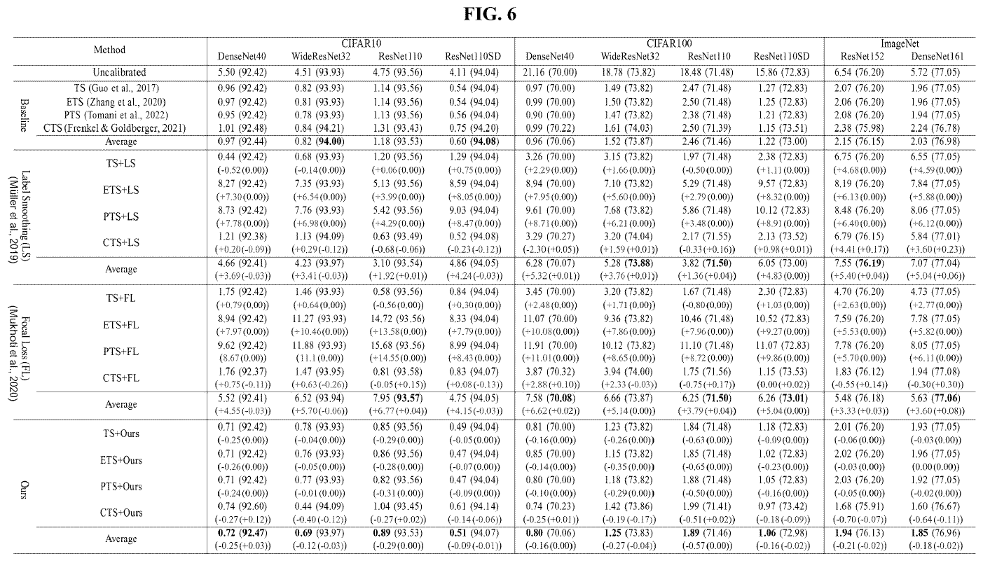

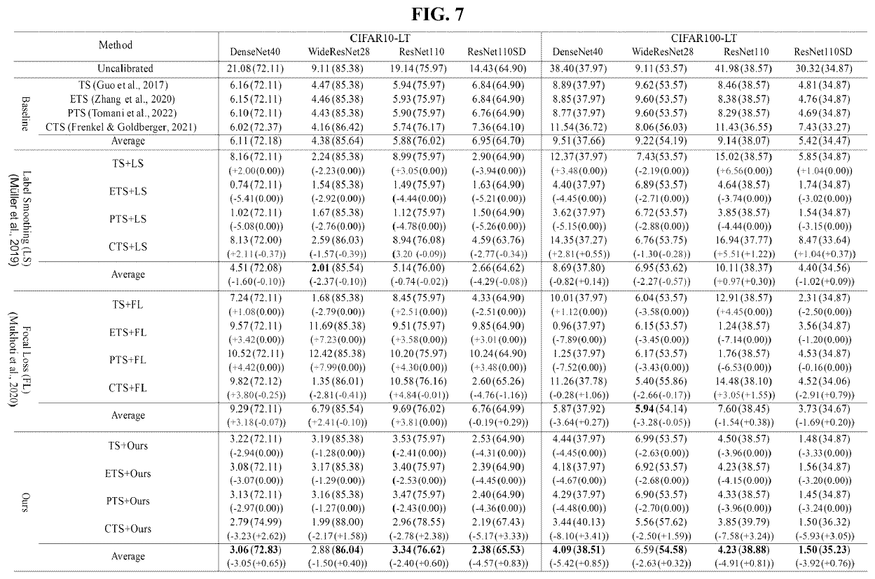

FIGS. 6 to 9D are exemplary diagrams for describing effects derived by a method for controlling a loss scale by class according to one embodiment.

FIG. 6 shows a comparison of results (ours) of applying the method for controlling a loss scale by class according to one embodiment with the existing baseline. In this case, FIG. 6 shows a case where the number of data sets for each class is the same, and FIG. 7 shows a case where the number of data sets for each class is different.

As can be seen in FIG. 7, it can be seen that performance improvement is guaranteed even when the number of data sets for each class is different. The total loss is the same, but performance may be improved because the balance is achieved.

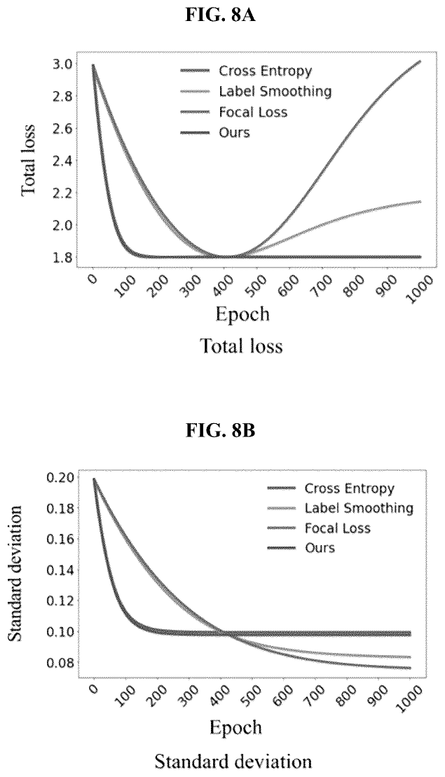

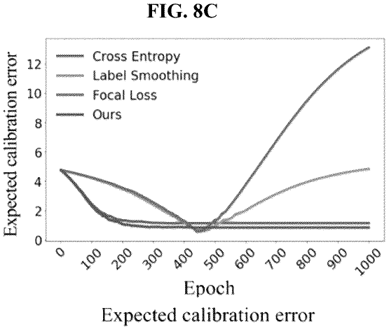

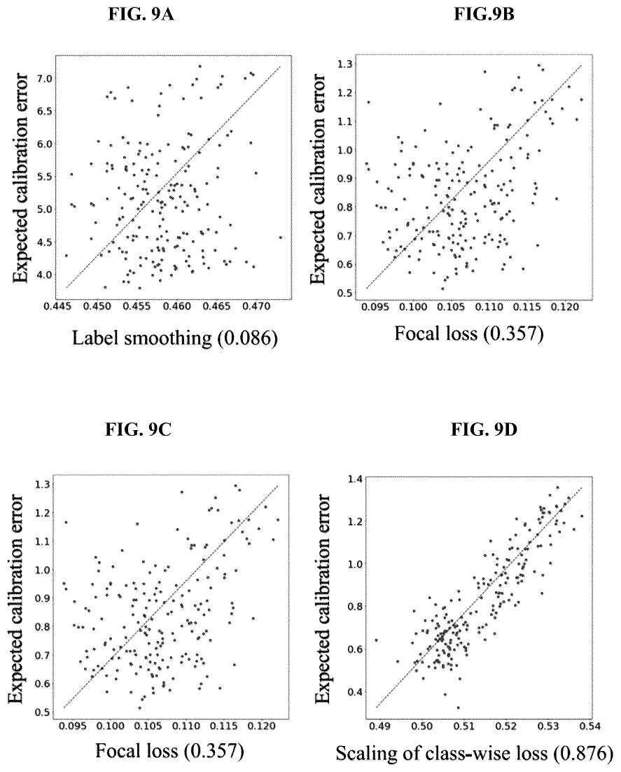

FIGS. 8A to 9D show experimentally verified results, and performance improvement can be confirmed compared to existing methods.

In the present specification, a module may mean a functional and structural combination of hardware for carrying out the technical idea of the present disclosure and software for driving the hardware. For example, the “module” may mean a logical unit of a predetermined code and a hardware resource for executing the predetermined code, and does not necessarily mean physically connected code or a single type of hardware.

The above-described method may be implemented as an application or in the form of program instructions that may be executed through various computer components and recorded on a computer-readable recording medium. The computer-readable recording medium may include program instructions, a data file, a data structure, or the like, alone or in combination.

The program instructions recorded on the computer-readable recording medium may be specially designed and configured for the present disclosure, or may be known and available to those skilled in the field of computer software.

Examples of the computer-readable recording medium include magnetic media such as hard disks, floppy disks, and magnetic tapes, optical media such as CD-ROMs and DVDs, magneto-optical media such as floptical disks, a hardware device specially configured to store and execute program instructions, such as ROM, RAM, flash memory, or the like.

Examples of the program instructions include not only machine language codes such as those produced by a compiler, but also high-level language codes that may be executed by a computer using an interpreter or the like. The hardware device may be configured to operate as one or more software modules to perform processing according to the present disclosure, and vice versa.

According to disclosed embodiments, a new post-calibration method, referred to as class-wise loss scaling, in which class-wise training losses are synchronized by controlling a loss scale factor is suggested, which makes it possible to show superior calibration performance while maintaining overall accuracy of an original model, and to, by using a pre-trained model as an initial model, reduce additional calculations for model calibration and design a calibration framework to be easily used in post-calibration methods.

In addition, by compensating a training loss of an overfitting class with a training loss of an underfitting class, the overall training loss is maintained, which has an effect of preventing performance degradation after model calibration.

Although the present disclosure has been described with reference to the embodiments, it is to be understood that one ordinary skilled in the art can make various changes and modifications to the present disclosure without departing from the spirit and scope of the present disclosure as hereinafter claimed.

1: A method for controlling a loss scale by class for post-hoc calibration of a pre-trained neural network, is the method executed in a computing device including one or more processors and a memory storing one or more programs executed by the one or more processors, the method comprising:
identifying class-wise losses of a neural network;
analyzing a relative correlation of the class-wise losses by normalizing the identified class-wise losses;
estimating a class-wise loss scaling weight for determining a degree of training for each class according to a result of the analyzing of the relative correlation; and
calculating weighted values of the class-wise losses by applying the estimated class-wise loss scaling weights to the identified class-wise losses of the neural network, and deriving a total loss of the neural network for post-hoc calibration by summing the identified class-wise loss and the weighted value of the class-wise loss for each class,
wherein the estimating of the class-wise loss scaling weight includes:
estimating a class-wise weight parameter including a slope parameter and a horizontal translation parameter using a sigmoid basis function; and
estimating the class-wise loss scaling weight based on the class-wise weight parameter, and
the class-wise loss scaling weight is estimated using Equation 3 below:
$$\text{?} = \text{?} ( {\overline{ℒ}}_{{C}_{i}} ; α , β ) := \frac{β}{1 + exp ( - \text{?} / α )} - \frac{β}{2} \qquad ( Equation 3 )$$
$${w}_{i} : Class - wise loss scaling weight$$
$$\text{?} \text{indicates text missing or illegible when filed}$$
α: Slope parameter
β: Horizontal translation parameter
σ: Sigmoid function [symbol]
_{C}_{ᵢ} Normalized class-wise loss.

2: The method of claim 1, wherein in the identifying, the class-wise loss ( [symbol] _{C}_{ᵢ}) is calculated using Equation 1:
$${ℒ}_{{C}_{i}} = - {\sum }_{( x , y ) ∈ {D}_{i}} δ ( y ) log ( {ϕ}_{c} ( x ) ) \qquad ( Equation 1 )$$
wherein cᵢ is i-th class;
δ is a function to convert y to one-hot vector;
y is a label for correct answer value;
x is an input data;
ϕ_{c} is a present Preset calibration function; and
Dᵢ is a set of samples labeled with class i.

3: The method of claim 2, wherein in the analyzing, the class-wise loss is normalized by Equation 2:
$${\overline{ℒ}}_{{C}_{i}} = \frac{{ℒ}_{{C}_{i}} - 𝔼 [ {ℒ}_{{C}_{i}} ]}{\sqrt{𝔼 [ {ℒ}_{{C}_{i}}^{2} ] - {𝔼}^{2} [ {ℒ}_{{C}_{i}} ]}} \qquad ( Equation 2 )$$
where [symbol] _{C}_{ᵢ} is normalized class-wise loss; and [symbol]
is a function to calculate mean.

4.-5: (canceled)

6: The method of claim 3, wherein in the estimating of the class-wise loss scaling weight, an objective function is designed to reduce variance of class-wise training losses as in Equation 4 to optimize values of the slope parameter and the horizontal translation parameter:
$$( Equation 4 )$$
$${ℒ}_{σ ( a , β )} = η ( {ℒ}_{C}^{1} ) \approx \sqrt{{\sum }_{i = 1}^{c} {( {ℒ}_{{C}_{i}}^{0} - σ ( {\overline{ℒ}}_{{C}_{i}}^{1} ; α , β ) \cdot ( {ℒ}_{{C}_{i}}^{1} - {ℒ}_{{C}_{i}}^{0} ) - 𝔼 [ {ℒ}_{C}^{1} ] )}^{2}}$$ [symbol]
_{σ(α,β)}: Objective function to optimize the slope parameter (α) and the horizontal translation parameter (β)
where c is the number of classes;
σ′ is sigmoid function;
E is a function to calculate mean;
η( [symbol] _{C}¹) is a function for standard deviation of class-wise training losses after first iteration; [symbol]
_{C}_{ᵢ}⁰ is class-wise training loss for i-th class before first training iteration; and [symbol]
_{C}_{ᵢ}¹ is class-wise training loss for i-th class after first training iteration.

7: The method of claim 6, wherein the weighted value of the class-wise losses is calculated using Equation 5:
$${ℒ}_{{scale}_{i}} = {w}_{i} {ℒ}_{{C}_{i}} \qquad ( Equation 5 )$$ [symbol]
_{scale}_{ᵢ} is a weighted value of the class-wise loss;
L_{Ci} is a class-wise loss; and
wᵢ is a class-wise loss scaling weight.

8: The method of claim 7, wherein in the deriving of the total loss, the total loss (L_{Total}) is derived by Equation 6:
$${ℒ}_{Total} = {\sum }_{i = 1}^{C} ( 1 + {w}_{i} ) {ℒ}_{{C}_{i}} \qquad ( Equation 6 )$$
where c is the number of classes;
wᵢ is class-wise loss scaling weight; and [symbol]
_{C}_{ᵢ} is class-wise loss.

9: An apparatus for controlling a loss scale by class for post-hoc calibration of a pre-trained neural network, the apparatus comprising:
one or more processors;
a memory storing one or more programs executed by the one or more processors;
a loss identification module configured to identify class-wise losses of the neural network;
an analysis module configured to analyze a relative correlation of the class-wise losses by normalizing the identified class-wise losses;
a weight estimation module configured to estimate a class-wise loss scaling weight for determining a degree of training for each class according to a result of the analyzing the relative correlation; and
a total loss derivation module configured to calculate weighted values of the class-wise losses by applying the estimated class-wise loss scaling weights to the identified class-wise losses of the neural network, and derive a total loss of the neural network for post-hoc calibration by summing the identified class-wise loss and the weighted value of the class-wise loss for each class,
wherein the weight estimation module is configured to estimate a class-wise weight parameter including a slope parameter and a horizontal translation parameter using a sigmoid basis function and estimate the class-wise loss scaling weight based on the class-wise weight parameter, wherein the class-wise loss scaling weight is scaling weight is estimated using Equation 3 below:
$$\text{?} = σ ( \text{?} ; α , β ) \text{?} \frac{β}{1 + exp ( - \text{?} / α )} - \frac{β}{2} \qquad ( Equation 3 )$$
$$\text{?} \text{indicates text missing or illegible when filed}$$
wᵢ: Class-wise loss scaling weight
α: Slope parameter
β: Horizontal translation parameter
σ: Sigmoid function [symbol]
_{C}_{ᵢ}: Normalized class-wise loss.

10: A non-transitory computer readable storage medium storing a computer program comprising one or more instructions that, when executed by a computing device having one or more processors, cause the computing device to perform operations of:
identifying class-wise losses of a pre-trained neural network;
analyzing a relative correlation of the class-wise losses by normalizing the identified class-wise losses;
estimating a class-wise loss scaling weight for determining a degree of training for each class according to a result of the analyzing of the relative correlation; and
calculating weighted values of the class-wise losses by applying the estimated class-wise loss scaling weights to the identified class-wise losses of the neural network, and deriving a total loss of the neural network for post-hoc calibration by summing the identified class-wise loss and the weighted value of the class-wise loss for each class,
the estimating of the class-wise loss scaling weight includes:
estimating a class-wise weight parameter including a slope parameter and a horizontal translation parameter using a sigmoid basis function; and
estimating the class-wise loss scaling weight based on the class-wise weight parameter, and
the instructions cause the computing device to estimate the class-wise loss scaling weight using Equation 3 below:
$$\text{?} = σ ( \text{?} ; α , β ) := \frac{β}{1 + exp ( - \text{?} / α )} - \frac{β}{2} \qquad ( Equation 3 )$$
$$\text{?} \text{indicates text missing or illegible when filed}$$
wᵢ: Class-wise loss scaling weight
α: Slope parameter
β: Horizontal translation parameter
σ: Sigmoid function [symbol]
_{C}_{ᵢ}: Normalized class-wise loss.
